(19) United States
(12) Patent Application Publication
(10) Pub. No.: US 2009/0180597 A1
(43) Pub. Date: Jul. 16, 2009

(54) SMART MESSAGES FOR UNIFIED MESSAGING AND CALLTREE INTEGRATION

(75) Inventors: James Jackson, Austin, TX (US); Mehrad Yasrebi, Austin, TX (US)

Correspondence Address: AT & T LEGAL DEPARTMENT - GB;ATTN: PATENT DOCKETING, ROOM 2A- 207, ONE AT & T WAY, BEDMINISTER, NJ, 07921, US

(73) Assignee: AT & T KNOWLEDGE VENTURES, L.P., Reno, NV (US)

(21) Appl. No.: 12/014,988

(22) Filed: Jan. 16, 2008

(51) Int. Cl. H04M 3/51

(52) U.S. Cl. 379/88.13

(57) ABSTRACT

In an integrated unified messaging (UM) and interactive voice system, a unified messaging application server provides a plurality of different types of messages. The unified messaging application server is responsive to a media server which serves the different types of messages to at least one user device. The unified messaging application server is also responsive to an interactive voice server, that communicates with the unified messaging application server and the media server. The interactive voice server includes a plurality of nodes that can be accessed by the unified messaging application server, such that the user device is provided with messages that allow the user device to access the interactive voice server.

### FIELD OF THE INVENTION

The present disclosure relates generally to unified messaging, and more particularly to smart messages that provide an integrated unified messaging (UM) and interactive voice response system.

### BACKGROUND OF THE INVENTION

An interactive voice response system, which is sometimes referred to as a CallTree, is a software application that accepts a combination of voice telephone input and/or touch-tone keypad selection and provides appropriate responses. An interactive voice response system is usually a part of a larger application that includes database access.

The typical interactive voice response system uses an embedded software application. For example, banks often use an interactive voice response system to allow customers to perform financial transactions such as accessing or updating bank accounts using a telephone. Large businesses routinely use interactive voice response systems in call centers to route incoming calls. Typically in a call center interactive voice response system, to resolve a product issue, a customer dials a customer care telephone number and enters a sequence of touch-tone keypad inputs. After obtaining relevant information regarding the issue, the call center interactive voice response system either presents an issue resolution, logs the issue for further investigation or connects the caller to a customer representative. Additionally, movie theaters use interactive voice response systems for selective information lookup, such as finding movie schedules, theater locations, etc.

A unified messaging system is a messaging service that provides a single mailbox where the user can receive and manage multiple types of messages, including e-mail, voice mail, wireless voicemail and faxes. The user can usually access this mailbox from any compatible computer with internet access or from any touchtone telephone. Since all messages are located in one place, there is no need to check multiple voicemail systems, answering machines, fax machines and e-mail inboxes.

Referring now to FIG. 1, a block diagram illustrates a representative unified messaging system (UMS) 100. A plurality of communications devices 101, 102 can represent any common computing or telephone device (e.g., a landline phone, a cellular phone, or a landline or wireless laptop computer) capable of communicating with a switched network such as a PSTN 103 or packet switched network such as the Internet 104. A unified messaging system server 105 is capable of receiving messages from the PSTN 103 or the Internet 104 and storing the messages in an access unit and message store 106. The unified messaging system server 105 can manage a number of different message types (e.g., e-mail, fax, landline and wireless voicemail messages), and direct them to an end user via a media server 107. The user interacts with the media server 107 via a real time protocol (RTP) channel.

In a unified messaging system, if someone leaves a message for the user on the user's home phone, the user can be alerted on his wireless phone that there is a new message waiting for the user. The user can access the unified messaging mailbox from a compatible computer or from a touchtone telephone. If the unified messaging system includes text-to-speech technology, the user can call into the unified messaging system and have his e-mail read to him over a telephone. The user of a unified messaging system can listen to, forward and compose voicemails. Likewise, a user of a unified messaging system can review, forward or print faxes. Lastly, the user of a unified messaging system can read, forward and compose e-mails. The user can typically perform these functions from the inbox of the unified messaging software on his computer or from his touch tone phone.

### SUMMARY OF THE DISCLOSURE

The present disclosure relates to a system, method and computer readable medium for integrating a unified messaging (UM) and interactive voice system. A unified messaging application server is provided with different types of messages, such as e-mail, voicemail and faxes. The unified messaging application server interacts with a media server to serve the different types of messages to at least one user device. An interactive voice server communicates with the unified messaging application server and the media server. The unified messaging application server is able to access multiple nodes on the interactive voice server and sets up a call to the interactive voice server. The media server provides the user device with smart messages that allow the user device to access the interactive voice server.

### BRIEF DESCRIPTION OF THE FIGURES

FIG. 1 is a block diagram of a conventional unified messaging system.

FIG. 2 is a flow diagram for the conventional unified messaging system of FIG. 1.

FIG. 3 is a block diagram of a computer system that can be used to implement various embodiments disclosed herein.

FIG. 4 is a block diagram of the integrated unified messaging system and interactive voice system.

FIGS. 5A-5D are an activity diagram of the integrated unified messaging and interactive voice system of FIG. 4.

### DETAILED DESCRIPTION

In view of the foregoing, the present disclosure, through one or more of its various aspects, embodiments and/or specific features or sub-components, is thus intended to bring out one or more of the advantages as specifically noted below.

According to an aspect of the present disclosure, an integrated unified messaging (UM) and interactive voice system include a unified messaging application server, for providing different types of messages. The unified messaging application server is responsive to a media server which serves the different types of messages to at least one user device. The unified messaging application server is also responsive to an interactive voice server that communicates with the unified messaging application server and the media server. The system provides scripted call flow functionality with multiple layered nodes that can be accessed by the unified messaging application server without accessing nodes of a previous layer. The user device is provided with messages that allow the user device to access the interactive voice server.

According to a further aspect of the present disclosure, the media server provides the user device with a link, and when a user selects the link, the unified messaging application server sets up a connection to a node of the interactive voice server, thereby permitting the user device to interact with the interactive voice server.

According to a further aspect of the present disclosure, the unified messaging application is responsive to a message store that stores multiple messages, and at least one message that includes an additional mappings file.

According to a further aspect of the present disclosure, the unified messaging application server converts the additional mappings file into voice extensible markup language (VXML) code and passes the voice extensible markup language code and associated audio message to the media server.

According to a further aspect of the present disclosure, the media server, in response to the user selected link, accesses a URL in the voice extensible markup language code.

According to a further aspect of the present disclosure, the unified messaging application server, in response to the access of the URL in the voice extensible markup language code, establishes a call to the interactive voice server.

According to a further aspect of the present disclosure, the interactive voice server, in response to the call from unified messaging application server, engages the media server and provides access to a specific node of the scripted call flow functionality.

According to a further aspect of the present disclosure, the interactive voice server is responsive to a web client interface that manages the interactive voice server.

According to a further aspect of the present disclosure, the web client allows recording of a voicemail, associating a voicemail with a specific node, and broadcasting of voicemail messages to multiple mailboxes.

According to anther aspect of the present disclosure, a method is provided for integrating a unified messaging (UM) system and an interactive voice system. Different types of messages are received at a unified messaging system server. The different types of messages are provided to a media server to serve at least one user device. Communications are established between the unified messaging server and an interactive voice server that provides scripted call flow functionality with multiple layered nodes that can be accessed by the unified messaging application server without accessing nodes of a previous layer. The user device is provided with messages that allow the user device to access the interactive voice server.

According to a further aspect of the present disclosure, the media server provides the user device with a link and, when a user selects the link, the unified messaging application server sets up a connection to a node of the interactive voice server, thereby permitting the user device to interact with the interactive voice server.

According to a further aspect of the present disclosure, multiple messages are stored, and at least one message includes an additional mappings file.

According to a further aspect of the present disclosure, the unified messaging application server converts the additional mappings file into voice extensible markup language (VXML) code and passes the voice extensible markup language code and associated audio message to the media server.

According to a further aspect of the present disclosure, the media server, in response to the user selected link, accesses a URL in the voice extensible markup language code.

According to a further aspect of the present disclosure, the unified messaging application server, in response to the access of the URL in the voice extensible markup language code, establishes a call to interactive voice server.

According to a further aspect of the present disclosure, the interactive voice server, in response to the call from unified messaging application server, engages the media server and connects the call to a specific node with the interactive voice server.

According to a further aspect of the present disclosure, the interactive voice server is managed with a web client interface.

According to a further aspect of the present disclosure, at least one voicemail is recorded and associated with a specific node, and voicemail messages are broadcasted to multiple mailboxes with the web client interface.

According to a further aspect of the present disclosure, a computer readable medium integrates a unified messaging (UM) system and an interactive voice system. A message providing code segment provides multiple different types of messages to a unified messaging system server. A message serving code segment serves the different types of messages from a media server to at least one user device. A communication establishing code segment establishes communications between the unified messaging application server and an interactive voice server that provides scripted call flow functionality with multiple layered nodes that can be accessed by the unified messaging application server without accessing nodes of a previous layer. The user device is provided with messages that allow the user device to access the interactive voice server.

According to a further aspect of the present disclosure, a voicemail is recorded and associated with a specific node, and voicemail messages are broadcasted to multiple mailboxes with a web interface.

In an enterprise environment, it is common to have both a voicemail platform and a interactive voice system. There is often a need for a group of individuals to listen to a specific message in an interactive voice system. This is especially true for a closed user group (CUG). An interactive voice system can place outbound calls directly to all individuals in the closed user group at a predetermined time, but this creates a sub-optimal use of call resources, and it is likely that many individuals will not be available to participate at the time the interactive voice system places the call. Alternatively, it is also common for an enterprise voicemail platform to support a broadcast facility that allows a voicemail message to be dropped into a group of voice mailboxes. The message can then instruct the recipient to call back into the interactive voice system or to reply to the message to participate. There are however disadvantages to this approach. It also creates a sub-optimal user experience and greatly limits the possibility of application interaction between the voicemail platform and the interactive voice system platform. For instance, there is no way for a subscriber to be immediately routed to a specific node in the interactive voice system. The subscriber is limited to listening to the voice mail message that has been dropped in his voice mailbox by the interactive voice system.

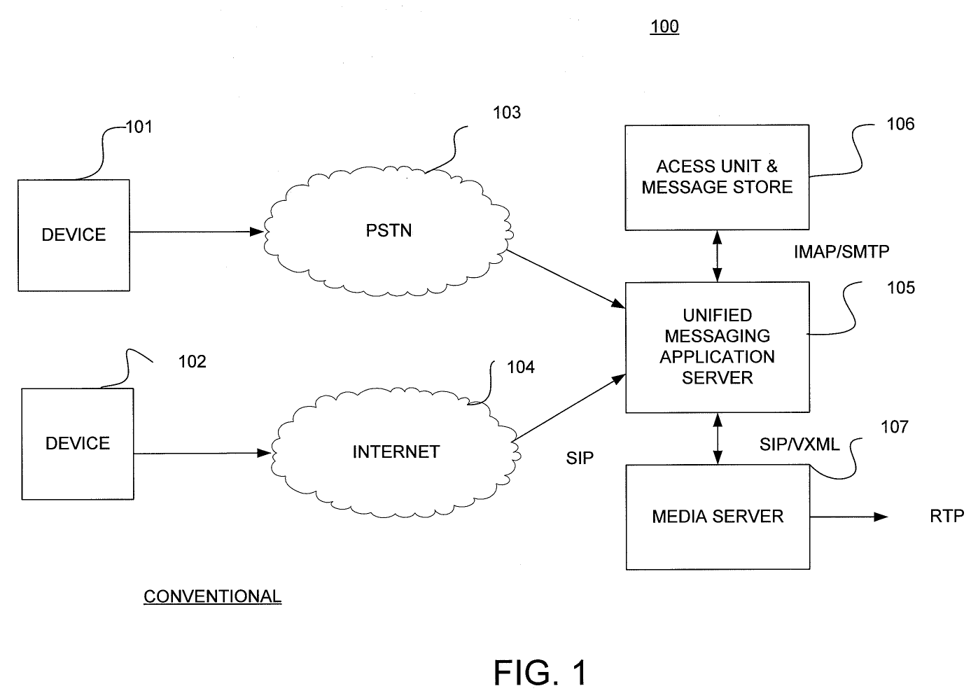

According to the present disclosure, a “smart message” is both an enhanced service and a new type of message created for a unified messaging system, where the message contains a link back to specific nodes in an interactive voice system or CallTree. Such messages are created and dropped into a mailbox or group of mailboxes by an application rather than by a caller. As an example, a company could drop a voicemail message into all its employee mailboxes. The voicemail message could play “We are asking all employees to vote on this issue, please press 81 to vote yes or 82 to vote no”. When the recipient presses 81, they are pulled into a specific node of an interactive voice or CallTree where they hear additional prompts/announcements. The conventional e-mail centric unified messaging system of FIG. 1 utilizes a Session Initiation Protocol (SIP)/voice extensible markup language (VXML) model that follows a typical call flow. In order to implement these “smart messages”, however, the conventional unified messaging system of FIG. 1 must be modified.

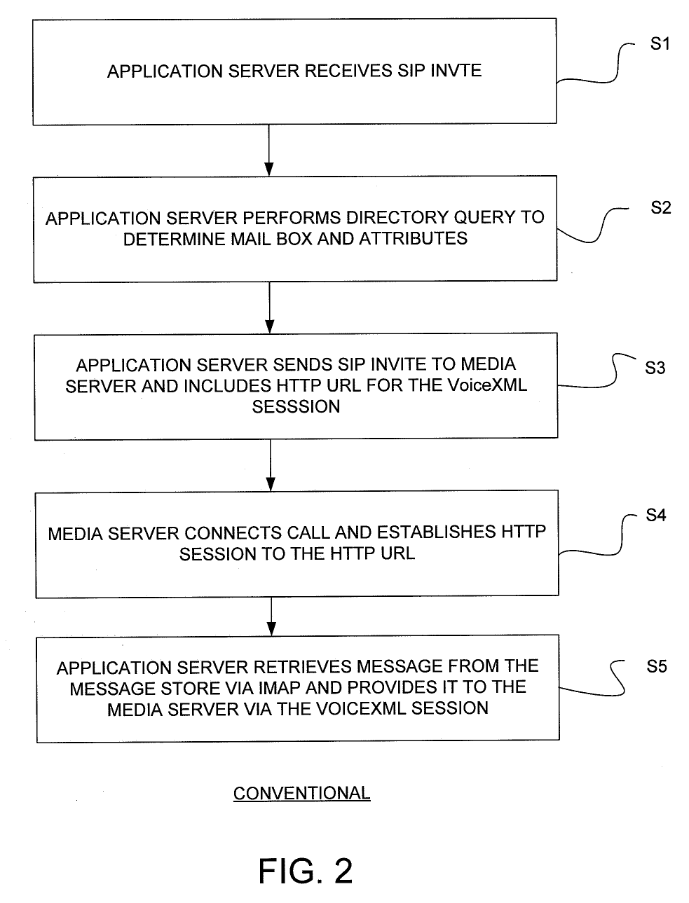

Referring now to FIG. 2, a flow diagram illustrates the typical call flow of the conventional unified messaging system of FIG. 1. In step S1, the application server 105 receives a SIP INVITE. In step S2, the application server 105 performs a directory query to determine mailbox and attributes. In step S3, the application server 105 sends a SIP INVITE to the media server 107 and includes an HTTP URL for a voice extensible markup language session. In step S4, the media server 107 connects a call and establishes an HTTP session to the HTTP URL. It should be noted that the application server 105 acts as the voice extensible markup language server and the media server 107 acts as the voice extensible markup language client. In order to play a message, the application server 105 in step S5 retrieves the message from the message store 106 via IMAP or any other suitable facility and provides it to the media server 107 via the voice extensible markup language session. The media server 107 is responsible for playing out messages and capturing user input, e.g., processing of the media stream (RTP).

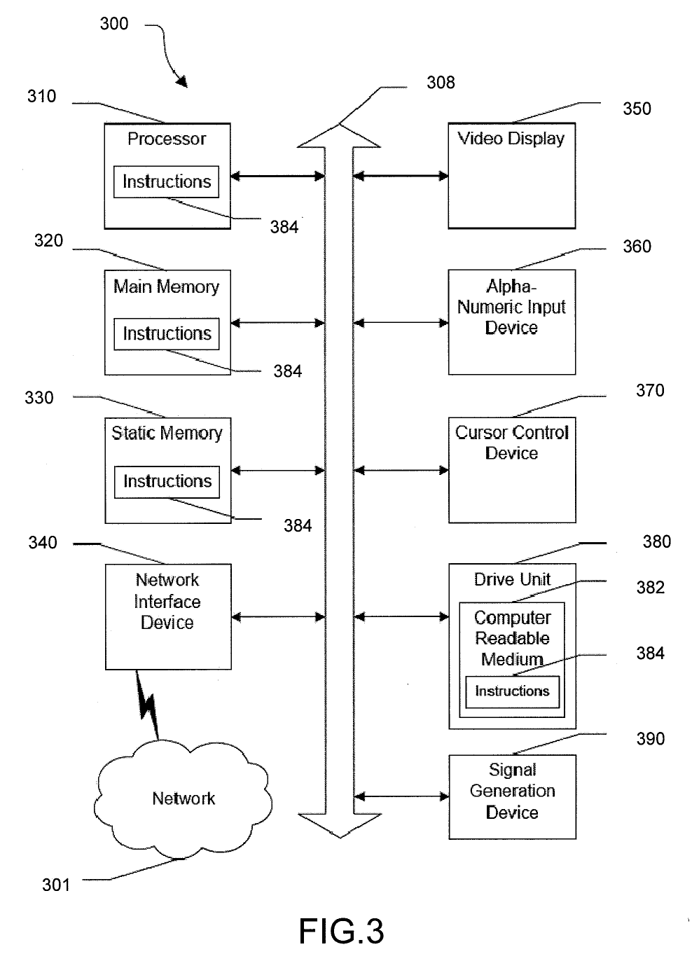

Referring to FIG. 3, an illustrative embodiment of a general computer system, on which smart messages for unified messaging and call tree integration can be implemented, is shown and is designated 300. The computer system 300 includes a set of instructions 384 that can be executed to cause the computer system 300 to perform any one or more of the methods or computer based functions disclosed herein. The computer system 300 may operate as a standalone device or may be connected, e.g., using a network 301, to other computer systems or peripheral devices.

As illustrated in FIG. 3, the computer system 300 may include a processor 310, e.g., a central processing unit (CPU), a graphics processing unit (GPU), or both. Moreover, the computer system 300 can include a main memory 320 and a static memory 330 that can communicate with each other via a bus 308. As shown, the computer system 300 may further include a video display unit 350, such as a liquid crystal display (LCD), an organic light emitting diode (OLED), a flat panel display, a solid state display, or a cathode ray tube (CRT). Additionally, the computer system 300 may include an input device 360, such as a keyboard, and a cursor control device 370, such as a mouse. The computer system 300 can also include a disk drive unit 380, a signal generation device 390, such as a speaker or remote control, and a network interface device 340.

In a networked deployment, the computer system 300 may operate in the capacity of a server or as a client user computer in a server-client user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

In a particular embodiment, as depicted in FIG. 3, a disk drive unit 380 may include a computer-readable medium 382 in which one or more sets of instructions 384, e.g. software, can be embedded. Further, the instructions 384 may embody one or more of the methods or logic as described herein. In a particular embodiment, the instructions 384 may reside completely, or at least partially, within the main memory 320, the static memory 330, and/or within the processor 310 during execution by the computer system 300. The main memory 320 and the processor 310 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 382 that includes instructions 384 or receives and executes instructions 384 responsive to a propagated signal, so that a device connected to a network 301 can communicate voice, video or data over the network 301. Further, the instructions 384 may be transmitted or received over the network 301 via the network interface device 340.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

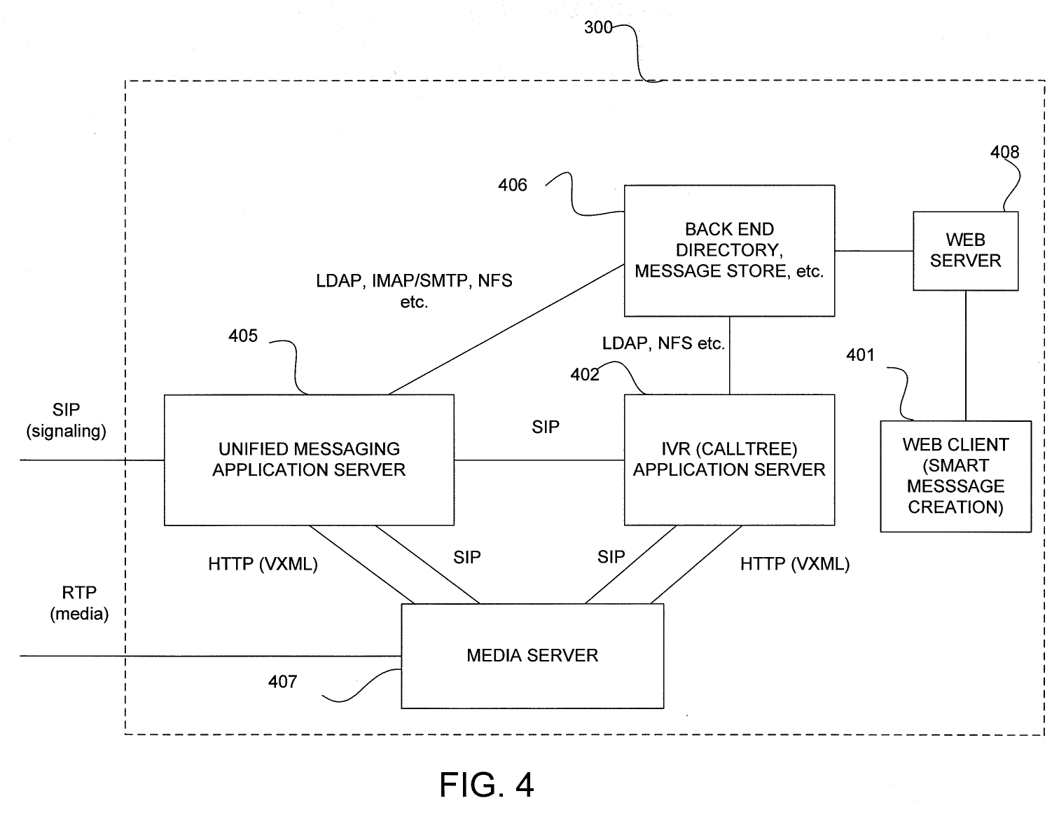

Referring now to FIG. 4, a block diagram illustrates the integrated unified messaging and interactive voice system 300 of the present disclosure, and it includes a unified messaging application server 405, an interactive voice (CallTree) application server 402, and a media server 407. The integrated unified messaging and interactive voice system 300 provides a new mechanism for creating “smart messages” by using a web client 401 and a web server 408. The system also preferably utilizes the existing CallTree web-based creation tool for the interactive voice application server 402. The web-based interface allows recording of a voicemail, association of the voicemail with specific nodes in a CallTree, and broadcast of the voicemail message to closed user group mailboxes.

In an e-mail centric unified messaging application, all messages are stored as e-mails in a back end directory and message store unit 406. A voicemail is simply an audio attachment to an e-mail message. There are various options for appending these links to voicemail messages. For instance, a special e-mail attachment (e.g., an extensible markup language file) can be created for these mappings. The mappings can associate user input (e.g., DTMF key) to a node in a CallTree (e.g., access number/nodeID). The integrated unified messaging and interactive voice system 300 preferably includes logic that allows it to retrieve the mappings file and use it as part of the dynamic voice extensible markup language creation process.

The integrated unified messaging and interactive voice system 300 also preferably includes the creation of a reserved DTMF prefix key. The DTMF sequences associated with “smart messages” should not overlap with the standard DTMF sequences used to interact with a unified messaging application. All “smart message” input options preferably begin with a reserved DTMF key (for example, “8”) and this key should be excluded from the standard unified messaging menu.

The integrated unified messaging and interactive voice system 300 also preferably includes logic that allows it to transfer to the CallTree application and include a new session initiation protocol header that specifies the CallTree nodeID. The CallTree application must assume control of the existing session initiation protocol call. To accomplish this task the integrated unified messaging and interactive voice system 300 creates a new session initiation protocol invite to the access number of the CallTree. It also includes a new session initiation protocol header that identifies the specific node within the CallTree.

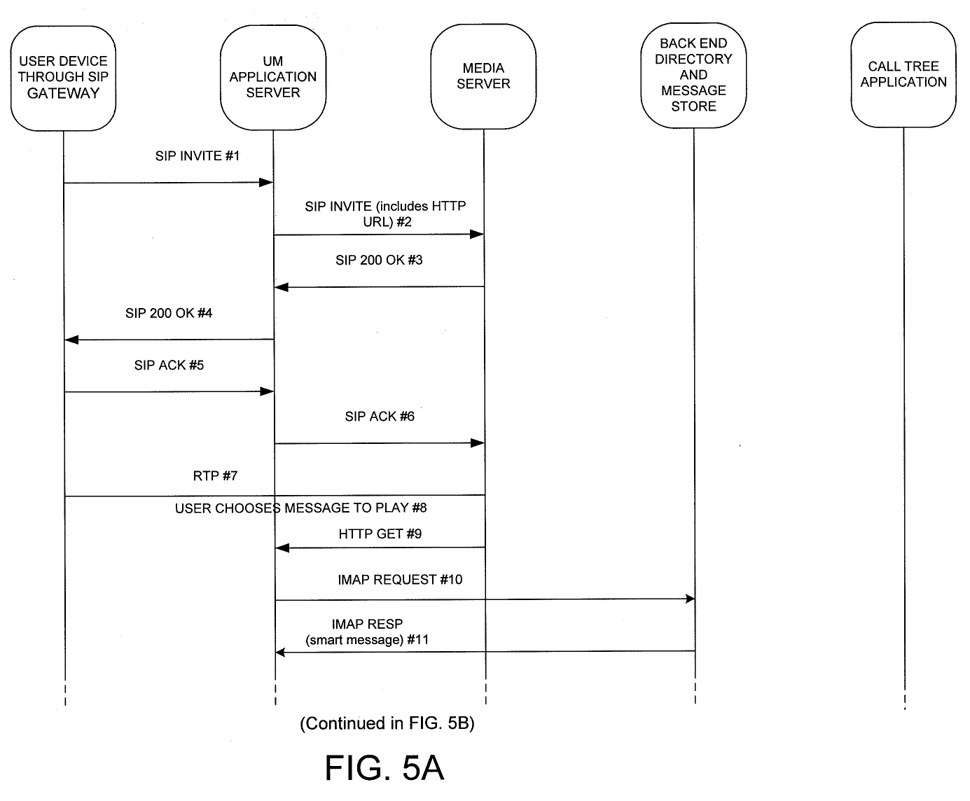

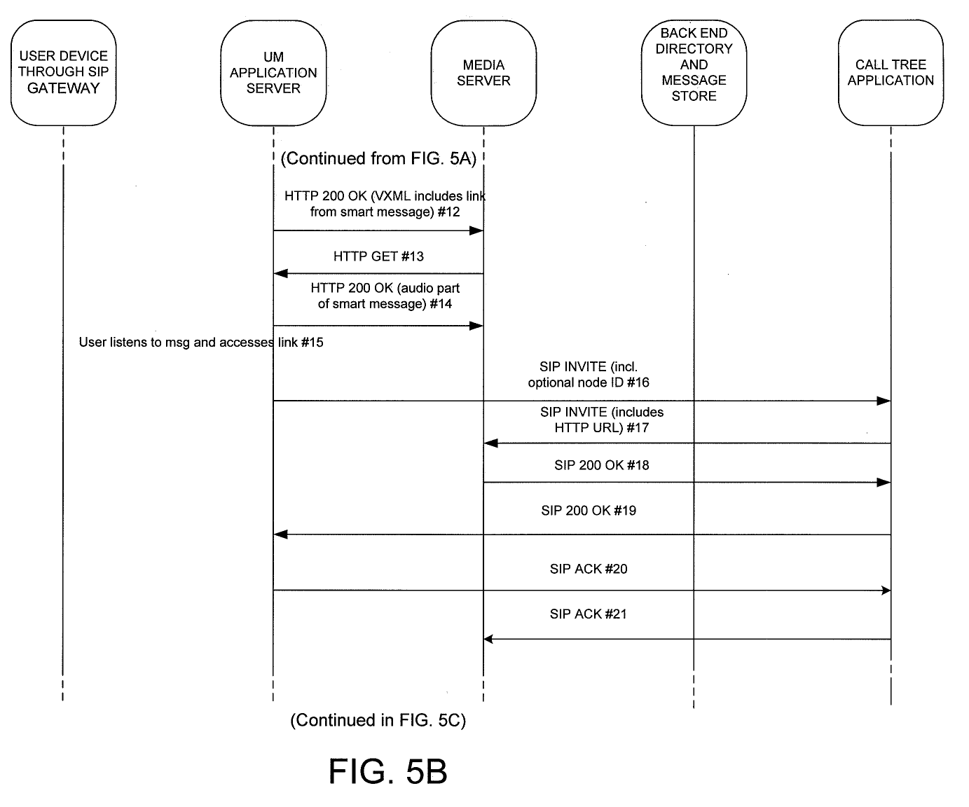

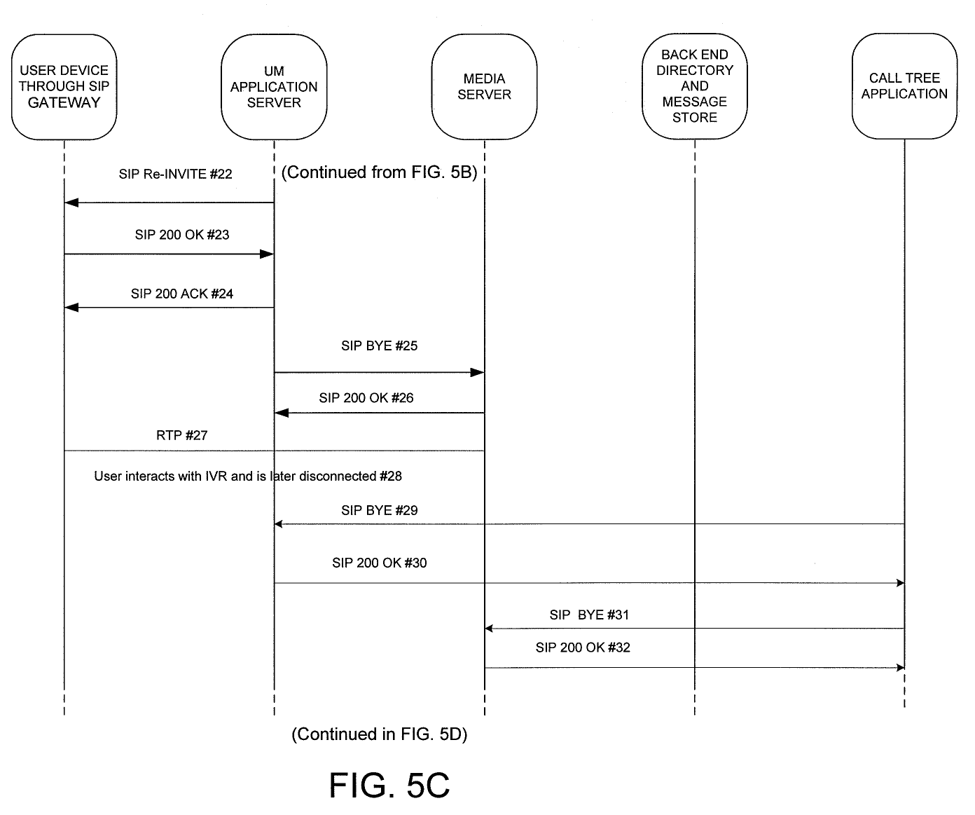

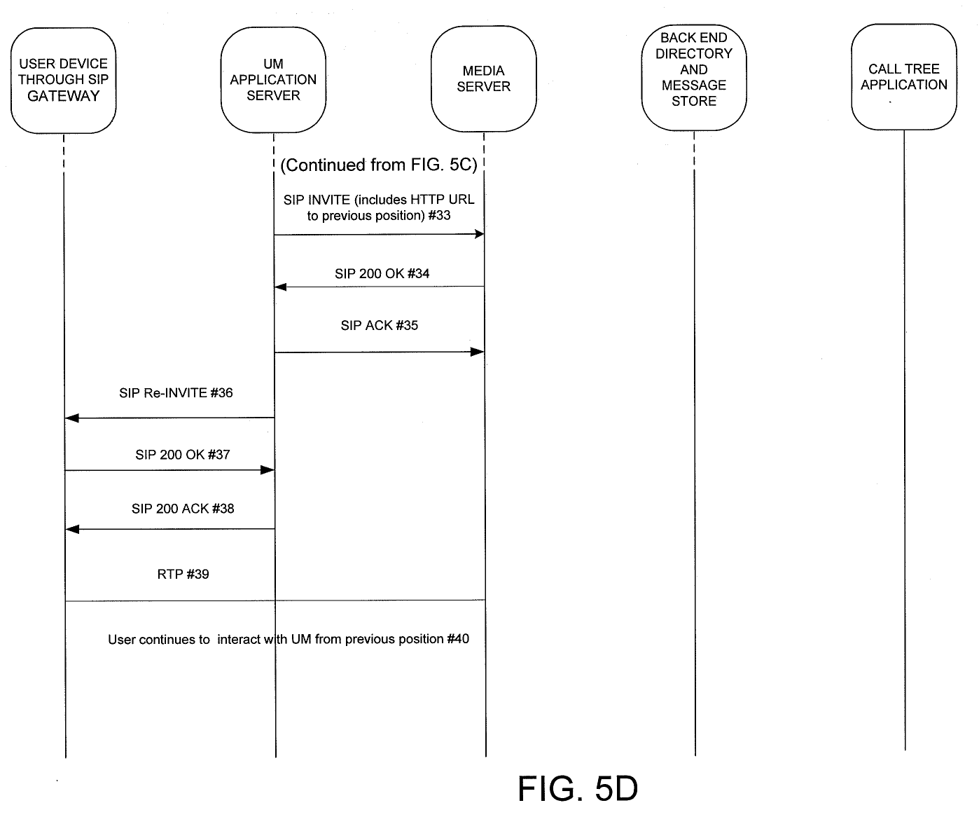

Referring now to FIGS. 5A-D, an activity chart illustrates the operation of the integrated unified messaging and interactive voice system 300 of the present disclosure. Messages #1-#6 establish the initial call to UM application server. Message #7 establishes a media stream, and the user interacts with UM application via DTMF or voice command. The UM application server plays prompts/announcements to user. Message #8 allows the user to choose and listen to a “smart message”. Message #9 allows the media server to request a message via an HTTP GET to the UM application server. With messages #10-11, the UM application server retrieves message from the backend via IMAP. Message #12 allows the UM application server to extracts link from the “smart message” and to incorporate them into the VXML supplied to the media server. Messages #13-14 enable the media server to get the audio part of “smart message” from UM application server. Message #15 enables a user to listen to a “smart message” and to select the link option. With messages #16-21, the UM application server engages the CallTree application server. It provides the existing media description from the gateway in the INVITE, as well as an optional CallTree node ID. Messages #22-24 enable the UM application server to update the media description to the gateway with a SIP Re-INVITE. Messages #25-26 cause the UM application server to terminate the relationship with the media server. Messages #27-28 establish the media stream, a user interacts with the CallTree application via DTMF or voice command. The CallTree plays prompts/announcements to the user. Messages #29-32 terminate the CallTree session either by timeout or user selection. Messages #33-38 allow the UM application server to re-engage the media server with the URL to a previous position in the menu, and update the media description to the gateway. Messages #39-40 allow the user to interact with the UM application from a previous position.

There are several advantages that the integrated unified messaging and interactive voice system 300 provides over conventional systems. For example, the integrated unified messaging and interactive voice system 300 minimizes the possibility that a call sent out to subscribers in a closed user group will be unanswered. The integrated unified messaging and interactive voice system 300 re-uses the notification schemes inherent in modem unified messaging systems, such as the AT&T Unified Messaging, to inform the closed user group subscribers of an impending message, where any and all of the following properties may be used for notification to maximize responsiveness to the closed user group message. For example, in the corporate survey example described above, the system will maximize participation in the corporate survey.

Other advantages include an originating subscriber (a corporate announce e-mail ID) may be used as a key contact list member. One or more levels of urgency flags may be used to indicate urgency. A subject line of e-mail notifications may be used to attract attention and/or various flavors of pager notifications may be used to notify the target user of the awaiting message.

The integrated unified messaging and interactive voice system 300 advantageously allows for the creation of “smart messages” which provide tight integration between a unified messaging platform and a CallTree (interactive voice) platform, thereby improving the user experience.

Lastly, the integrated unified messaging and interactive voice system 300 of the present disclosure can be advantageously implemented in conjunction with modem voice over internet protocol (VoIP) systems and extensible markup language templates to enhance its integration into forthcoming state-of-the-art systems.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather, the disclosure extends to all functionally equivalent structures, methods, and uses such as are within the scope of the appended claims.

We claim:

1. An integrated unified messaging (UM) and interactive voice system, comprising:
a unified messaging application server, for providing a plurality of different types of messages, said unified messaging application server being responsive to a media server which serves the different types of messages to at least one user device, and said unified messaging application server also being responsive to an interactive voice server that communicates with the unified messaging application server and the media server and that provides scripted call flow functionality with a plurality of layered nodes that can be accessed by the unified messaging application server without accessing nodes of a previous layer;
wherein the user device is provided with messages that allow the user device to access the interactive voice server.

2. The system according to claim 1,
wherein the media server provides the user device with a link, and when a user selects the link, the unified messaging application server sets up a connection to a node of the interactive voice server, thereby permitting the user device to interact with the interactive voice server.

3. The system according to claim 2,
wherein the unified messaging application is responsive to a message store that stores a plurality of messages, and at least one message that includes an additional mappings file.

4. The system according to claim 3,
wherein the unified messaging application server converts the additional mappings file into voice extensible markup language (VXML) code and passes the voice extensible markup language code and associated audio message to the media server.

5. The system according to claim 4,
wherein the media server, in response to the user selected link, accesses a URL in the voice extensible markup language code.

6. The system according to claim 5,
wherein the unified messaging application server, in response to the access of the URL in the voice extensible markup language code, establishes a call to the interactive voice server.

7. The system according to claim 6,
wherein the interactive voice server, in response to the call from unified messaging application server, engages the media server and provides access to a specific node of the scripted call flow functionality.

8. The system according to claim 1,
wherein the interactive voice server is responsive to a web client interface that manages the interactive voice server.

9. The system according to claim 8,
wherein the web client allows recording of a voicemail, associating a voicemail with a specific node, and broadcasting of voicemail messages to multiple mailboxes.

10. A method for integrating a unified messaging (UM) system and an interactive voice system, comprising:
receiving a plurality of different types of messages at a unified messaging system server;
providing the different types of messages to a media server to serve at least one user device; and
establishing communications between the unified messaging server and an interactive voice server that provides scripted call flow functionality with a plurality of layered nodes that can be accessed by the unified messaging application server without accessing nodes of a previous layer;
wherein the user device is provided with messages that allow the user device to access the interactive voice server.

11. The method according to claim 10,
wherein the media server provides the user device with a link and, when a user selects the link, the unified messaging application server sets up a connection to a node of the interactive voice server, thereby permitting the user device to interact with the interactive voice server.

12. The method according to claim 11, further comprising:
storing a plurality of messages, and at least one message that includes an additional mappings file.

13. The method according to claim 12,
wherein the unified messaging application server converts the additional mappings file into voice extensible markup language (VXML) code and passes the voice extensible markup language code and associated audio message to the media server.

14. The method according to claim 13,
wherein the media server, in response to the user selected link, accesses a URL in the voice extensible markup language code.

15. The method according to claim 14,
wherein the unified messaging application server, in response to the access of the URL in the voice extensible markup language code, establishes a call to interactive voice server.

16. The method according to claim 15,
wherein the interactive voice server, in response to the call from unified messaging application server, engages the media server and connects the call to a specific node with the interactive voice server.

17. The method according to claim 10, further comprising:
managing the interactive voice server with a web client interface.

18. The method according to claim 17, further comprising:
recording of a voicemail, associating a voicemail with a specific node, and broadcasting of voicemail messages to multiple mailboxes with the web client interface.

19. A computer readable medium, for integrating a unified messaging (UM) system and an interactive voice system, comprising:
a message providing code segment that provides a plurality of different types of messages to a unified messaging system server;
a message serving code segment that serves the different types of messages from a media server to at least one user device; and
a communication establishing code segment that establishes communications between the unified messaging application server and an interactive voice server that provides scripted call flow functionality with a plurality of layered nodes that can be accessed by the unified messaging application server without accessing nodes of a previous layer;
wherein the user device is provided with messages that allow the user device to access the interactive voice server.

20. The computer readable medium according to claim 19, which further allows recording of a voicemail, associating a voicemail with a specific node, and broadcasting of voicemail messages to multiple mailboxes with a web interface.
